(19) United States
(12) Patent Application Publication
(10) Pub. No.: US 2008/0316540 A1
(43) Pub. Date: Dec. 25, 2008

(54) METHOD AND DEVICE FOR IMAGING OF A ROTOGRAVURE FORM AND ROTOGRAVURE FORM SO IMAGED

(76) Inventors: Andreas Scheffler, Altenholz (DE); Sven Bruns, Altenholz (DE)

Correspondence Address: SCHIFF HARDIN, LLP;PATENT DEPARTMENT, 6600 SEARS TOWER, CHICAGO, IL, 60606-6473, US

(21) Appl. No.: 12/140,375

(22) Filed: Jun. 17, 2008

(30) Foreign Application Priority Data
Jun. 20, 2007 (DE) 10 2007 028 838.9
Jun. 21, 2007 (DE) 10 2007 029 099.5

(51) Int. Cl. B41C 1/02

(52) U.S. Cl. 358/3.29

(57) ABSTRACT

In a method for imaging of a rotogravure form or an imaged rotogravure form, the rotogravure form is imaged by providing cups therein of different dimensions to achieve different tone values or print densities. Image data are assembled from image tiles to provide for the imaging of the rotogravure form. The imaging of the rotogravure form is preferably by engraving.

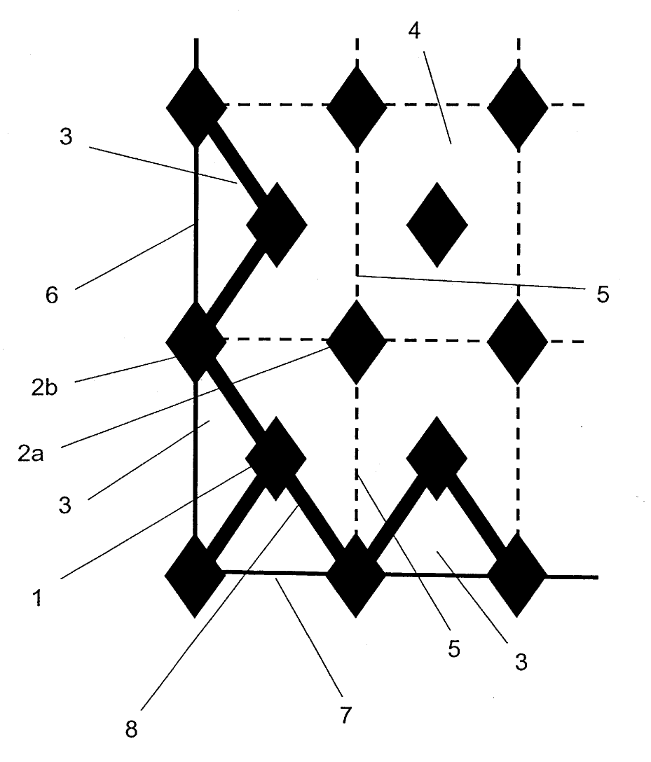

### BACKGROUND

The preferred embodiment concerns a method and a device for imaging (preferably by engraving) rotogravure forms in which or with which cups are provided.

Furthermore, the preferred embodiment concerns an imaging rotogravure form.

### SUMMARY

It is an object to improve the imaging of a rotogravure form. An imaging data processing should thereby advantageously be made easier and/or be automated; and/or the rotogravure form should be improved in terms of its printing behavior; and/or an improved contour sharpness of the printed print image should be achieved.

In a method for imaging of a rotogravure form or an imaged rotogravure form, the rotogravure form is imaged by providing cups therein of different dimensions to achieve different tone values or print densities. Image data is assembled from image tiles to provide for the imaging of the rotogravure form. The imaging is preferably by engraving.

### BRIEF DESCRIPTION OF THE DRAWINGS

The drawing FIGURE shows imaging, preferably by engraving, of a rotogravure form according to a preferred embodiment.

### DESCRIPTION OF THE PREFERRED EMBODIMENT

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

According to the preferred embodiment image data provided to image the rotogravure form are assembled from image tiles (advantageously are parquetted).

The print image to be printed out can thereby be assembled in a simpler, faster and more automated manner and can also be analyzed if needed.

According to the preferred embodiment, a respective image tile is advantageously constructed or selected such that it contains a cup and/or parts of neighboring cups. With such image tiles the print image can advantageously be detected and prepared (in terms of data) completely and without gaps via a suitable parquetting.

However, as of a specific minimum volume or less there are cups in a rotogravure form that do not reliably and/or completely dispense the ink accommodated in them to the printing substrate. For example, this depends on the one hand on the cup volume, and on the other hand also on the consistency of the ink (in particular its viscosity). This can hereby lead to a misprint that is conspicuous and unwanted in tone value curves but also in edge contours of an image since such a contour could then appear frayed, for example. This in particular applies in publication printing in equal measure as in packaging printing.

So that partial cups that, for example, contribute to the improvement of a contour are also properly printed, according to a further solution according to the preferred embodiment (for which independent protection is also claimed) it is provided that at least one only partially formed cup is connected in an ink-conducting manner with at least one adjacent cup that could itself also be a partial cup. In this manner the cup and the partial cups or two or more partial cups together form a larger, possibly more bizarrely fashioned cup or cup system that can properly dispense the ink.

According to the preferred embodiment, border cups truncated by an image border are also provided as partial cups in the rotogravure form due to conditions of image data. This can also lead to the situation that the partially formed cup is a border cup truncated by an image border due to conditions of image data, which border cup is introduced into the print form only as a partially formed cup and itself has difficulties in the ink dispensation. According to the preferred embodiment, it is also preferably provided in this case that an ink-conducting connection with a complete cup is established.

A preferred embodiment of the method provides that the portions of neighboring cups at the borders are provided as partial cups given an image border tile placed at an image edge due to conditions of image data. According to the preferred embodiment, if necessary all portions of neighboring cups at edges (thus the partial cups that lie in the neighborhood of an edge) are connected with a cup completely comprised by the image border tile and/or with another partial cup or even with multiple cups or partial cups to avoid isolated partial cups.

According to the preferred embodiment, simply essentially rectangular image tiles are preferably used. Each image tile can then essentially include the region of a raster mesh of a cup image raster, for example. Other polygonal image tile shapes naturally are also conceivable, for example honeycomb shapes or rhombus shapes or even corner-less (for example tongue-shaped) image tiles.

Each image tile advantageously includes or comprises a central cup and (depending on the raster angle) significant portions of neighboring cups to be found, for instance, in diagonal directions of the image tiles or in the direction of the respective raster angle.

According to the preferred embodiment it can preferably be provided that connection options between cups and/or partial cups are provided in different directions. Cups and/or partial cups are preferably connected in pairs as needed; however, more cups or partial cups can also be connected with one another. Due to the provided connection options it is in particular also possible to provide selection criteria for the respective preferred connection and/or depending on the situation, for example in the form of a selection algorithm.

According to the preferred embodiment, whether a partial cup or an image tile are adjacent to an image border can advantageously be automatically detected via data processing in that image data (preferably provided before imaging of the rotogravure form) are scanned via per-cup and/or per-pixel surroundings comparison for cups or portions thereof placed at the edge of an image border and/or image border tiles, and these are thereby identified. For this the entire surroundings of a cup, a partial cup and/or a pixel of a cup or partial cup can be considered. Such a method can also be implemented in a self-learning manner in that, for example, preceding search sequences can be intelligently taken into account.

Independent protection is also respectively claimed for: a rotogravure form of the preferred embodiment that is characterized in that it is imaged according to the method; as well as for a device for imaging of a rotogravure form which forms cups in a rotogravure form, which device is characterized in that it possesses a controller (advantageously programming or programming capability) capable of working according to the method and/or set up for such a method. The method according to the preferred embodiment can in particular also be wholly or partially incorporated into a software with which the respective print job conditions can be predetermined.

A border segment of an image section according to the preferred embodiment, with regard to which the inventive method will be explained again in part, is shown in the Drawing FIGURE. Further features according to the preferred embodiment can also result from the drawing illustration; however, the preferred embodiment is not to be limited in its scope to this exemplary embodiment.

The Drawing FIGURE shows only schematically and by example a possible section from a raster image made up of cups. The cups are indicated as rhomboids 1, 2a, 2b. Rectangular image tiles 3, 4 whose borders are indicated with dashed lines 5 and with which the raster image is realized in a parquet manner have been respectively formed with a central cup 1.

A corner region of an image border has additionally been indicated in the Drawing FIGURE with solid lines 6, 7.

Cups 2b of which a portion lie outside of the image border are cut through by the line of the image border 6, 7. In a print form only that part of such a cup 2b that lies within the image is therefore respectively fashioned (advantageously engraved) in a print form in order to mark the image contour as sharply as possible, corresponding to the line of the image border.

As already mentioned, a central cup 1 and respectively one quarter of a neighboring cup in the corner regions of the image tile belong to the image tile.

The image tiles 3 are image border tiles that abut the image border 6, 7 and therefore also comprise partial cups of border cups 2b. They also comprise cups 2a that belong to multiple image tiles 3, 4. Image tiles 4 are inner image tiles that have in their corner regions only partial cups of cups 2a belonging to multiple image tiles. These inner cups 2a are completely formed on the print form in cooperation with the image tiles 3, 4.

However, as stated the border cups 2b are only partially formed insofar as they lie within the image border 6, 7. Small cup regions therefore arise that have difficulties in dispensing ink onto a printing substrate.

According to the preferred embodiment, image data are thereupon checked as to which image tiles are image tiles 3 and thus possess border cups 2b. Such border cups 2b are then connected in an ink-conducting manner with the respective central cup of the image border tile via additional ink channels 8 or cup through-cuts in order to thus generate an overall cup that altogether can also properly dispense ink from the border cups. These ink channels are thus generated (advantageous engraved) as well in the printing form in its imaging. A respective ink channel 8 to connect a partial cup 2b with a central cup 1 is thereby possibly sufficient.

With the method of the preferred embodiment, the imaging of the rotogravure form is improved. The imaging data processing is rendered easier and/or for improved automation. The rotogravure form is improved in terms of its printing behavior. Also contour sharpness of the print image is improved.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1. A method for imaging of a rotogravure form, comprising the steps of:
providing cups of different dimensions to image the rotogravure form to achieve different tone values or print densities; and
assembling image data provided for the imaging of the rotogravure form from image tiles.

2. A method according to claim 1 wherein at least some of the image tiles contain a cup and at least one partial cup formed by a portion of at least one adjacent cup.

3. A method according to claim 2 wherein the partial cup is connected in an ink-conducting manner with said cup.

4. A method according to claim 1 wherein border cups truncated by an image border due to conditions of image data are also provided as partial cups in the rotogravure form.

5. A method according to claim 2 wherein the partial cup comprises a border cup truncated by an image border due to conditions of the image data.

6. A method according to claim 1 wherein portions of neighboring cups at image borders comprise partial cups at image border tiles at said image borders due to conditions of the image data.

7. A method according to claim 6 wherein all neighboring cups in a respective image border tile are connected with a cup entirely included by the image border tile.

8. A method according to claim 1 wherein the image tiles are polygonal.

9. A method according to claim 1 wherein each image tile substantially encompasses a region of a raster mesh of a cup image raster.

10. A method according to claim 1 wherein each image tile encompasses a central cup and partial cups formed of neighboring cups located substantially on diagonal directions of the image tile.

11. A method according to claim 1 wherein ink flow connections are provided between a cup and partial cups are provided in different directions in at least some of the image tiles.

12. A method according to claim 1 where the image data provided for the imaging of the rotogravure form are searched for border tiles located at an edge of an image border, and these are thus identified.

13. A method according to claim 1 wherein the imaging of the rotogravure form is by engraving.

14. A rotogravure form, comprising:
a plurality of imaging cups of different dimensions to achieve different tone values of print densities; and
the image cups being in a pattern in the rotogravure form according to image tiles laid out according to assembled image data.

15. A rotogravure form according to claim 14 wherein each of the image tiles contains a cup and a plurality of partial cups formed by respective portions of adjacent cups of the image tile.

16. A rotogravure form according to claim 15 wherein the cup is a central cup.

17. A rotogravure form according to claim 16 wherein for image tiles at borders the partial cups connect with said cup of each image tile at the borders by ink connecting channels.

18. A rotogravure form according to claim 14 wherein the imaged cups comprise engraved cups.

19. A system for imaging of a rotogravure form providing cups of different dimensions to achieve different tone values of print densities, comprising:
a controller for assembling image data provided for the imaging of the rotogravure form from image tiles.

20. A system of claim 19 wherein each image tile has a cup and a plurality of partial cups formed of a portion of respective adjacent cups of respective image this.

21. A system of claim 19 wherein ink channels connect the partial cups to the cup in image tiles at borders.

22. A method for imaging of a rotogravure form, comprising the steps of:
providing cups of different dimensions to image the rotogravure form to achieve different tone values or print densities;
assembling image data provided for the imaging of the rotogravure form from image tiles; and
each image tile contains a central cup and a plurality of partial cups formed by a portion of respective adjacent cups.

23. A method of claim 22 wherein the partial cups are connected to the central cup by ink-conducting channels at image tiles at a border.

24. A method for imaging of a rotogravure form in which cups of different dimensions are engraved into the rotogravure form to achieve different tone values or print densities, comprising the steps of:
assembling image data provided for the imaging of the rotogravure form like parquets from image tiles, the image tiles comprising image border tiles at an image border and inner image tiles, and wherein the image border tiles differ from the inner image tiles.

25. A method according to claim 24 wherein the image border tiles contain at least one only partially designed cup connected in an ink-conducting manner with at least one adjacent cup of the image border tiles.

26. A method according to claim 25 wherein the at least one only partially designed cup of the image border tiles is a border cup truncated by an image border and that is connected in an ink-conducting manner with an adjacent central cup of the image border tiles.

27. A method according to claim 24 wherein the inner image tiles contain no cups connected with one another in an ink-conducting manner.

28. A method according to claim 27 wherein the inner image tiles contain a central cup and inner partial cups belonging to multiple image tiles, said inner partial cups not being connected with the central cup in an ink-conducting manner.
